(19) United States
(12) Patent Application Publication
(10) Pub. No.: US 2006/0123708 A1
(43) Pub. Date: Jun. 15, 2006

(54) Angular joint of a window frame of a motor vehicle door

(76) Inventors: Michael Fuetterer, Hildrizhausen (DE); Christoph Jung, Herrenberg (DE); Markus Riedel, Sulzburg (DE); Juergen Zahn, Altensteig (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/527,456

(22) PCT Filed: Aug. 21, 2003
(86) PCT No.: PCT/EP03/09272

§ 371 Date: Oct. 31, 2005

(30) Foreign Application Priority Data
Sep. 12, 2002 (DE) 102 42 237.0

(51) Int. Cl. B60J 5/04

(52) U.S. Cl. 49/502

(57) ABSTRACT

In an angular joint of a window frame of a motor vehicle door, the window frame is formed, at least in one region, from at least one continuously cast aluminum profile. The at least one continuously cast aluminum profile is joined to an angular profile, and it is intended to configure the angular joint simply, in an esthetically pleasing manner, and without disturbing seams. In such an angular joint, the at least one profile to be joined is the support for external paneling, and the external paneling extends in the longitudinal direction of the at least one profile at least into the far corner of the angular profile. The paneling, the profile and the support extending therefrom can be configured as a one-piece, integral part.

### BACKGROUND AND SUMMARY OF THE INVENTION

This invention relates to an angular joint of a window frame of a motor vehicle door.

Such an angular joint is known, for example, from German document DE 199 47 209 A1. In the case of an angular joint of this type, difficulties and a relatively high production cost are created, in practice, in establishing a transition between the at least one profile and the angular joint element, which transition is invisible from the outside.

The invention concerns itself with the problem of furnishing an improvement in this regard.

This problem is solved by a design of an angular joint of the generic type according to the invention.

Advantageous and expedient designs are the subject of dependent claims.

The invention is based on the general notion of providing at least one of the two profiles to be joined together with a paneling, which extends into the corner region of the window frame and by which a substantial region can remain fully concealed to the outside. The remaining residual region can be outwardly covered by an additional screen. Facing the vehicle interior, the angular profile and the transitions from this to tied frame profiles are covered by an internal frame trim and door seals.

In order to provide firm footing for the external paneling extending into the corner region of the frame, against the support profile thereof, a part-region of the profile can overlap the angular profile, running in the longitudinal direction of the profile. In this overlap region, an angular profile, which is inserted into the support profile in a positive-locking and non-positive-locking arrangement, can additionally be fixed. This fixing can be realized by welding in place.

Particularly advantageous is an embodiment in which the external paneling is integrated in the profile to be joined and the support extending therefrom in a one-piece construction of paneling, support and profile to be joined.

The angular profile can be configured as a stand-alone component, especially a metal casting, at both ends of which there is tied a frame profile.

Also falling within the scope of the invention, however, is an embodiment in which the angular profile is an already integrated, one-piece component part of a frame profile extending into a window frame corner region, i.e. on which, according to the invention, only one more single frame profile can then be tied.

An illustrative embodiment of the invention is represented in the drawings.

### BRIEF DESCRIPTION OF THE DRAWINGS

FIG. 1 shows a view of an angular joint for a door frame, from the inside, and

FIG. 2 shows a view of this angular joint from the outside.

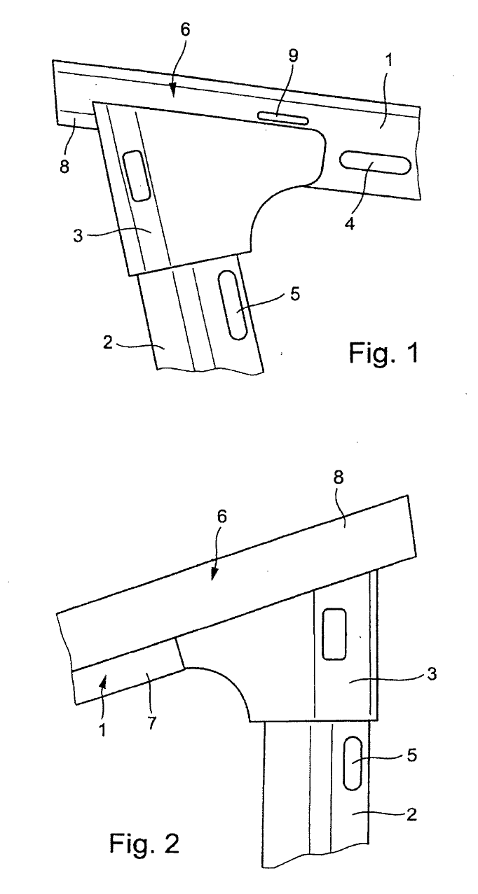

### DETAILED DESCRIPTION OF THE INVENTION

Of the two embodiments of an angular profile which have been set out above, as an illustrative embodiment only that one is described in which the angular profile serves as a joining element for two profiles mutually abutting in a corner region. In the other embodiment, one of the two joining regions is quite simply eliminated, since the angular profile is already an integral component part of one of the two profiles to be joined together.

Two continuously cast aluminum profiles 1, 2, meeting in a corner of a window frame of a motor vehicle door, which corner is situated high-up on the B-pillar, for example, of a motor vehicle, are joined together by a metal angular profile 3.

The joining consists in the fact that the angular profile 3, by the insertion of joining regions, provided at its ends, into a respective adjacent longitudinal cavity in the profiles 1, 2, is joined to these in a positive-locking and non-positive-locking arrangement. In order to enhance the force closure, slot welds can be provided in envisaged slotted regions 4, 5 of the profiles 1, 2.

The profile 1 representing the upper horizontal window region is provided with an external paneling 6, which juts out over the angular profile 3. Over the height of the profile 1, the paneling 6 encompasses only an upper part-region, whereas a lower part-region 7 of the profile 1 serves to receive a window frame seal profile.

In order to provide the paneling 6 on the profile 1 with additional footing, in the form of a support, in the region of the angular profile 3, a part-region 8 jutting over the angular profile 3 is provided on the profile 1. In this part-region 8 of the profile 1, an additional slot weld 9 can be provided between the angular profile 3 and the profile 1 in order to obtain an additional force closure.

The external cladding of the window frame profile 2 extending in the vertical axis can be realized by a screen (not represented in the drawing), which can be screwed, for example, on the profile 2. In the region in which this screen butts against the external paneling 6, a seal-filled seam can be provided.

If the paneling 6 is integrated into the profile 1, which is possible according to the invention, the paneling 6, the profile 1 and the support extending from the profile 1 are a single, one-piece component, i.e. are configured in one piece, totalling the components 1, 6, 7 and 8.

The angular joint construction according to the invention has the great advantage that, at the transition region between a profile and the angular profile, a continuous paneling ensures that there is no esthetically offensive transition present, without the need for extravagant machining. In principle, such an angular joint for a frame can also be realized in structural elements other than window frames of a motor vehicle door.

1-3. (canceled)

4. An angular joint of a window frame of a motor vehicle door, comprising:
at least one continuously cast aluminum profile,
an angular profile, the at least one profile being joined to the angular profile, and
an external paneling supported by the at least one profile and extending in the longitudinal direction of the at least one profile at least into a far corner of the angular profile.

5. The angular joint as claimed in claim 4, wherein the at least one profile overlaps at least a part-region of the angular profile and is joined thereto in a positive-locking and non-positive-locking arrangement.

6. The angular joint as claimed in claim 4, wherein the external paneling is integrated in the at least one profile and a support extending therefrom in a one-piece construction of the external paneling, the support and the at least one profile.

7. The angular joint as claimed in claim 5, wherein the external paneling is integrated in the at least one profile and a support extending therefrom in a one-piece construction of the external paneling, the support and the at least one profile.

8. An angular joint of a window frame of a motor vehicle door comprising:
an integrated component part including at least one aluminum profile, and an angular profile, and
an external paneling supported by the at least one profile and extending in the longitudinal direction of the at least one profile at least into a far corner of the angular profile.

9. An angular joint comprising:
at least one continuously cast aluminum profile,
an angular profile, the at least one profile being joined to the angular profile, and
an external paneling supported by the at least one profile and extending in the longitudinal direction of the at least one profile at least into a far corner of the angular profile.

10. The angular joint as claimed in claim 9, wherein the at least one profile overlaps at least a part-region of the angular profile and is joined thereto in a positive-locking and non-positive-locking arrangement.

11. The angular joint as claimed in claim 9, wherein the external paneling is integrated in the at least one profile and a support extending therefrom in a one-piece construction of the external paneling, the support and the at least one profile.

12. The angular joint as claimed in claim 10, wherein the external paneling is integrated in the at least one profile and a support extending therefrom in a one-piece construction of the external paneling, the support and the at least one profile.
